(19) United States
(12) Patent Application Publication
(10) Pub. No.: US 2024/0152387 A1
(43) Pub. Date: May 9, 2024

(54) METHOD, APPARATUS, ELECTRONIC DEVICE AND STORAGE MEDIUM FOR APPLICATION LAUNCH

(71) Applicant: Black Sesame Technologies (Chengdu) Co., Ltd., Chengdu (CN)

(72) Inventors: Youdan Hu, Chengdu (CN); Bintong Wen, Chengdu (CN)

(21) Appl. No.: 18/502,269

(22) Filed: Nov. 6, 2023

(30) Foreign Application Priority Data
Nov. 8, 2022 (CN) 202211394014.7

(51) Int. Cl. G06F 9/48; G06F 9/445

(52) U.S. Cl. CPC G06F 9/4843; G06F 9/445; G06F 2209/482

(57) ABSTRACT

A method, an apparatus, an electronic device, and a storage medium for application launch. The method includes: reading a dependency relationship of each application in a plurality of applications from a dependency description file carried by each application; generating an application launch sequence chain according to the dependency relationship; and sequentially launching the plurality of applications according to the application launch sequence chain.

### CROSS-REFERENCE TO RELATED APPLICATION

This application claims the benefit under 35 U.S.C. § 119(a) of the filing date of Chinese Patent Application No. 202211394014.7, filed in the Chinese patent office on Nov. 8, 2022. The disclosure of the foregoing application is herein incorporated by reference in its entirety.

### TECHNICAL FIELD

The present specification relates to the field of application management technologies, and in particular, to a method, an apparatus, an electronic device, and a storage medium for application launch.

### BACKGROUND

With the rapid development of computer technologies, more and more application software appears, and operating systems need to manage application software and system services installed by users.

Various application software in a computer system may typically be developed by different development teams. In a development stage of an application software, in order to make the development of the application software more efficient, a developer may make some function(s) of the application software call other software libraries or system service(s), that is, develop by standing on shoulders of giants, and if not doing so, a great amount of work is needed to be spent on redeveloping the work already previously done by other persons. Therefore, a lot of application software actually not only simply relies on their own functions to do some work, but also needs to rely on libraries, system services, etc. in systems to complete their functions provided to users.

Dependencies of application software may be divided into static dependencies and dynamic dependencies. A static dependency mainly means that an application software depends on a function library, a configuration file and the like, and a normal operation of the application software may be ensured only by installing the function library, the configuration file into a system together when the application software is installed. A dynamic dependency mainly means that an application software depends on system service(s) or other application software, and it needs to be ensured that the service(s) or other application software on which the application software depends are already running before the application software runs. Therefore, a launch sequence of various application software in a system in a launch stage of the application software needs to be reasonably determined so as to ensure a normal operation of each application software.

In the prior art, generally in an application deployment stage, a developer manually sets a reasonable application software launch sequence in advance according to a dependency relationship of various application software and writes the sequence into a device, so that an application launch module of the device launches each application according to the preset application software launch sequence in an application launch stage.

However, this manual setting of the launch sequence of the application software is inefficient and difficult to adapt to variable application deployment and update requirements.

### SUMMARY

In view of the foregoing, it is desirable to address the above technical problem(s) to provide a method, an apparatus, an electronic device, and a storage medium for application launch, to automatically determine a launch sequence of various application software in a system in an application software launch stage, so as to improve the efficiency of setting the launch sequence of the application software.

A method for application launch, comprises:
reading a dependency relationship of each application in a plurality of applications from a dependency description file carried by each application;
generating an application launch sequence chain according to the dependency relationship; and
sequentially launching the plurality of applications according to the application launch sequence chain.

In one embodiment, the dependency relationship of each application is written into a dependency description file carried by a current application in a development stage of the current application.

In one embodiment, writing the dependency relationship of each application into the dependency description file carried by the current application, includes:
by adopting an interface definition language, quoting an interface definition file of an application on which the current application depends in an interface definition file of the current application;
parsing the dependency relationship of the current application from the interface definition file of the current application by using an interface definition language parser; and
generating the dependency description file based on the dependency relationship by using an interface definition language generator.

In one embodiment, generating the application launch sequence chain according to the dependency relationship, includes:
dividing the plurality of applications into an application set without dependency relationship and an application set with dependency relationship;
generating a dependency relationship tree according to the dependency relationship of each application in the current application set with dependency relationship;
traversing the dependency relationship tree level by level by taking a root node of the dependency relationship tree as a starting point to read an application sequence formed by applications of all nodes; and
combining the application sequence and applications in the application set without dependency relationship and generating the application launch sequence chain.

In one embodiment, generating the dependency relationship tree according to the dependency relationship of each application in the current application set with dependency relationship, includes:
determining a dependency relationship matrix table among applications in the current application set with dependency relationship according to the dependency relationship of each application in the current application set with dependency relationship;
determining a dependency chain of the applications in the current application set with dependency relationship according to the dependency relationship matrix table; and
determining the dependency relationship tree of the applications in the current application set with dependency relationship according to the dependency chain.

In one embodiment, in the dependency relationship tree, for a node of each application, a node of an application on which a current application depends is located in a level lower than a location level of a node of the current application, and a node of an application depending on the current application is located in a level higher than the location level of the node of the current application.

In one embodiment, the method further comprises:
in response to an existence of a change application to be changed, acquiring a dependency relationship after change of the change application;
according to the dependency relationship after change, performing an update to determine an updated dependency relationship tree and an updated application set without dependency relationship, and obtaining an application sequence of the updated dependency relationship tree; and
according to the application sequence of the updated dependency relationship tree and applications in the updated application set without dependency relationship, determining an updated application launch sequence chain, and updating an existing application launch sequence chain by using the updated application launch sequence chain.

In one embodiment, in response to the change application to be changed being a new application to be installed, according to the dependency relationship after change, performing the update to determine the updated dependency relationship tree and the updated application set without dependency relationship, includes:
in response to the new application not depending on any application, adding the new application into an existing application set without dependency relationship to obtain the updated application set without dependency relationship, and taking an existing dependency relationship tree as the updated dependency relationship tree; and
in response to the new application depending on one or more application(s), accessing a node of the new application as a child node of a node of a most posterior application in an existing application launch sequence chain in the one or more application(s) on which the new application depends, to determine the updated application set without dependency relationship and the updated dependency relationship tree.

In one embodiment, in response to the change application to be changed being an existing application to be updated, according to the dependency relationship after change, performing the update to determine the updated dependency relationship tree and the updated application set without dependency relationship, includes:
in response to the existing application after update not depending on any application, taking an existing application set without dependency relationship as the updated application set without dependency relationship, and taking an existing dependency relationship tree as the updated dependency relationship tree;
in response to the existing application after update depending on one or more application(s) and there being no application depending on the existing application, accessing a node of the existing application as a child node of a node of a most posterior application in an existing application launch sequence chain in the one or more application(s) on which the existing application depends, to determine the updated application set without dependency relationship and the updated dependency relationship tree; and
in response to the existing application after update depending on one or more application(s) and there being one or more application(s) depending on the existing application, for the existing application and each of the application(s) depending on the existing application directly or indirectly, updating a node position of a current application, so that a node of an application on which the current application depends after update is located in a level lower than a location level of a node of the current application, and a node of an application depending on the current application is located in a level higher than the location level of the node of the current application, to determine the updated application set without dependency relationship and the updated dependency relationship tree.

In one embodiment, the method further comprises:
in response to an existence of a change application to be changed, acquiring a dependency relationship after change of the change application;
according to the dependency relationship after change, checking whether a cyclic dependency chain exists; and
in response to the cyclic dependency chain existing, stopping updating the change application into an existing application launch sequence chain, and sending an alarm information to an application developer terminal associated with the change application.

In one embodiment, combining the application sequence and the applications in the application set without dependency relationship and generating the application launch sequence chain, includes:
under a condition of keeping an application arrangement sequence in the application sequence unchanged, connecting head to tail the application sequence and various applications in the application set without dependency relationship to generate the application launch sequence chain.

An apparatus for application launch, comprises:
a dependency relationship reading module configured for reading a dependency relationship of each application in a plurality of applications from a dependency description file carried by each application;
an application launch sequence chain generating module configured for generating an application launch sequence chain according to the dependency relationship; and
an application launch module configured for sequentially launching the plurality of applications according to the application launch sequence chain.

An electronic device comprises a memory and a processor, the memory stories a computer program, and when executing the computer program, the processor implements following steps:
reading a dependency relationship of each application in a plurality of applications from a dependency description file carried by each application;
generating an application launch sequence chain according to the dependency relationship; and
sequentially launching the plurality of applications according to the application launch sequence chain.

A computer-readable storage medium stores thereon a computer program which, when executed by a processor, executes steps of:
reading a dependency relationship of each application in a plurality of applications from a dependency description file carried by each application;
generating an application launch sequence chain according to the dependency relationship; and
sequentially launching the plurality of applications according to the application launch sequence chain.

According to the above method, apparatus, electronic device, and storage medium for application launch, because each application carries in advance a dependency description file storing a dependency relationship, a system may automatically read the dependency relationship of each application from the application and automatically generate an application launch sequence chain according to the dependency relationship of each application, so that the applications may be launched in sequence according to the automatically generated application launch sequence chain in an application launch stage. This application solution realizes an automatic generation of an application launch sequence chain, and effectively improves an efficiency of setting an application launch sequence.

### BRIEF DESCRIPTION OF THE DRAWINGS

FIG. 1 is a diagram of an application environment of a method for application launch in one embodiment;

FIG. 2 is a schematic diagram of operations performed at different stages of an application in one example;

FIG. 3 is a schematic flowchart of a method for application launch according to an embodiment;

FIG. 4 is a listing of dependency relationships of applications in one example;

FIG. 5 is a schematic diagram of an example where an application P generates a dependency description file via an IDL;

FIG. 6 is a schematic flowchart of a method for application launch in an example;

FIG. 7 is a schematic diagram of an application set with dependency relationship and an application set without dependency relationship in one example;

FIG. 8 is a schematic diagram of a dependency relationship matrix table in one example;

FIG. 9 is a schematic diagram of a dependency chain in one example;

FIG. 10 is a schematic diagram of a dependency relationship tree in one example;

FIG. 11 is a schematic diagram of an application sequence in one example;

FIG. 12 is a schematic diagram of an application launch sequence chain in one example;

FIG. 13 is a schematic flowchart of a method for application launch in another embodiment;

FIG. 14 is a schematic diagram of an updated dependency relationship tree in one example;

FIG. 15 is a schematic diagram of a dependency relationship tree after moving an existing application B and its underlying directly and indirectly connected child nodes in one example;

FIG. 16 is a schematic diagram of an updated dependency relationship tree in another example;

FIG. 17 is a schematic diagram of a cyclic dependency chain in one example;

FIG. 18 is a block diagram of a structure of an apparatus for application launch in one embodiment; and

FIG. 19 is a diagram illustrating an internal architecture of an electronic device in one embodiment.

### DETAILED DESCRIPTION

In order to clearly explain objects, technical solutions and advantages of the techniques described herein, the techniques are described in further detail below with reference to accompanying drawings and embodiments. It should be understood that specific embodiments described herein are merely illustrative of the described technique and are not intended to limit the described techniques.

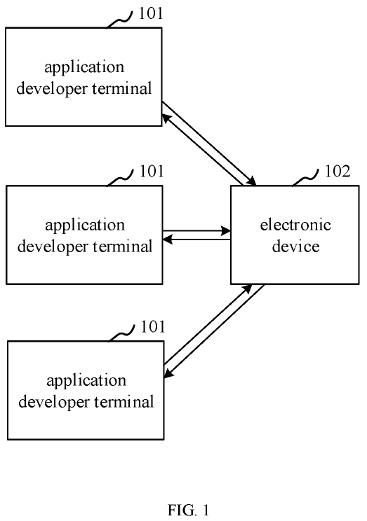

A method for application launch provided by the instant application may be applied to an application environment shown in FIG. 1. In an application development stage, different application developers may complete developments of different applications through respective application developer terminals 101, and carry dependency description files with dependency relationships in each of developed applications in application development processes. After the application development stage, in an application deployment stage of an electronic device 102, the electronic device 102 deploys each application to be deployed in the electronic device 102, and reads a dependency relationship of each application in a plurality of applications to be deployed from a dependency description file carried by each application in an application deployment process; and generates an application launch sequence chain according to the dependency relationship. After the application deployment stage, in an application launch stage in a running process of the electronic device 102, the electronic device 102 sequentially launches the applications in the electronic device 102 according to the application launch sequence chain. The electronic device 102 may be, but is not limited to, various smart phones, personal computers, notebook computers, tablet computers, and the like. The application developer terminal 101 may be various terminal devices such as a computer or a server.

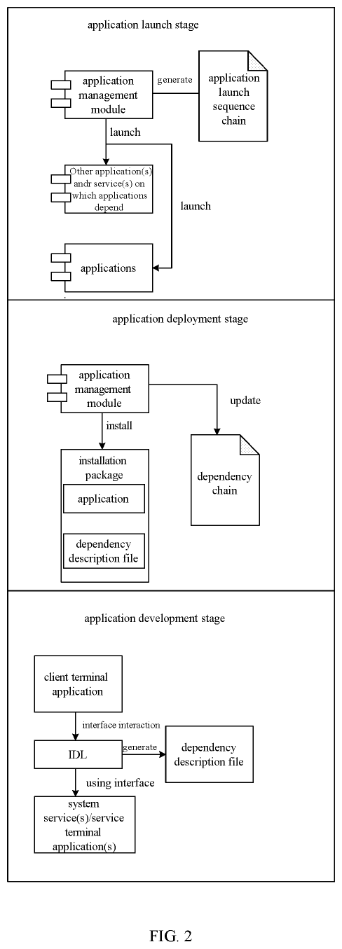

Illustratively, as is shown in FIG. 2, in an application development stage, an application deployment stage, and an application launch stage, the described techniques may relate to the following operations, respectively:
(1) in the application development stage: an application as a client uses an interface of a system service or a server application in a specification mode of an Interface Definition Language (IDL). A dependency description file is generated using an IDL parser.
(2) the application deployment stage: in a packaging and deploying process of the application, the dependency description file associated with the application is deployed into a running environment together, an application management module in the system analyses the dependency relationship, generates dependency chains of all the applications, and generates an application launch sequence chain.
(3) the application launch stage: an application launch module in the system is operated, to sequentially launch the applications according to the application launch sequence chain.

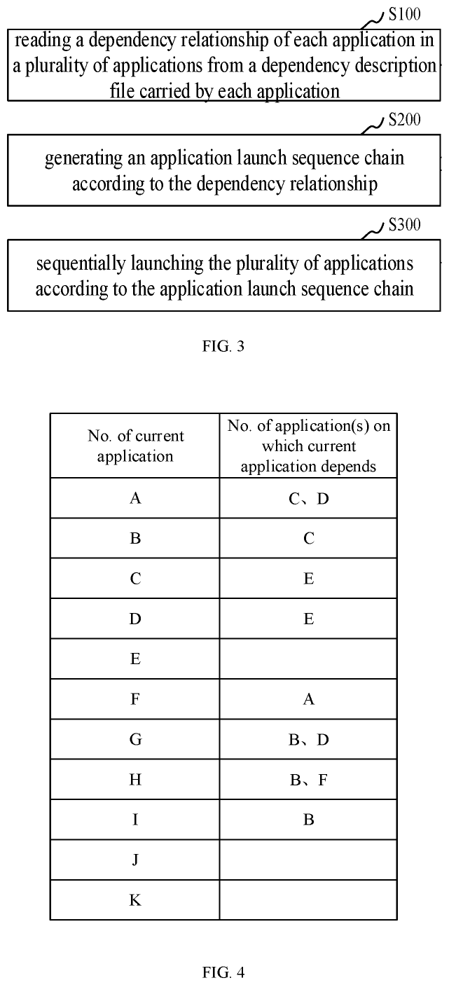

In one embodiment, as is shown in FIG. 3, a method for application launch is provided, is described by taking an application of the method to the electronic device 102 in FIG. 1 as an example, and includes following steps S100 to S300:
step S100, reading a dependency relationship of each application in a plurality of applications from a dependency description file carried by each application;
wherein, the step S100 may be performed in an application deployment stage.

A dependency relationship describes information of several application(s) on which each application depends.

A dependency relationship of each application is written into a dependency description file carried by a current application in a development stage of the current application. That is, before this step S100, the application developer terminal 101 has previously written the dependency relationship of each application into the dependency description file carried by the current application in the application development stage of each application.

After an application is developed, the application may be deployed into an operating environment of the electronic device 102 in an application deployment stage, and other data, such as a dependency library, a configuration file, and the like, required by the application may be packaged in a system in addition to the application itself in deployment. For example, an installation package of the application may further include a dependency description file generated in the development stage, in addition to the application itself and other data required by the application. Therefore, in the application deployment stage, in this step, the dependency relationship of each application may be conveniently read from the dependency description file carried by the application.

For example, when there are, in total, eleven applications, A to K, to be deployed, in this step, information of application(s) on which each application depends may be read from a carried dependency description file of each application and is listed in a listing of FIG. 4.

Step S200, generating an application launch sequence chain according to the dependency relationship;
wherein, the step S200 may be performed in an application deployment stage.

In an application deployment stage, in this step, the electronic device 102 performs a dependency relationship analysis according to the dependency relationships of the applications read in the previous step, to generate an application launch sequence chain that meets the dependency relationship requirement of each application.

The described techniques will further include an alternative solution of generating an application launch sequence chain according to the dependency relationship. However, it may be understood that there are many other ways to generate a corresponding application launch sequence chain according to the dependency relationship, and the reasonable application launch sequence chain that may be generated may not be single for the same plurality of applications to be deployed.

Step S300, sequentially launching the plurality of applications according to the application launch sequence chain.

The step S300 may be performed in an application launch stage.

In an application launch stage of the electronic device 102, in this step, a launch management module in the system may launch each application in sequence according to an application launch sequence chain in the current electronic device 102. In this way, it may be ensured that an application on which each application depends is already running at the time of launching each application, and thus the launched application may also run normally after launching.

According to the above method for application launch, each application carries a dependency description file with a dependency relationship stored therein in advance, so that the system may automatically read the dependency relationship of each application from the application and automatically generate an application launch sequence chain according to the dependency relationship of each application, and the applications may be sequentially launched according to the automatically generated application launch sequence chain in an application launch stage. This application solution realizes an automatic generation of an application launch sequence chain, and effectively improves an efficiency of setting an application launch sequence.

In a development stage, when a single application is developed, if a function of another application is used, the applications need to be called mutually, and the mutual calling has multiple calling modes, such as: a pipeline, a shared memory, a message queue, a socket and the like, which require both parties to realize a communication mechanism, and to be developed on a same platform. A problem of incompatibility will be caused if the development platforms and the development languages are inconsistent.

In conventional technologies, since various applications may be developed by different application developers, and development platforms and development languages used by the different application developers are likely to be different, so that the applications cannot call each other, a dependency of each application on system services and a dependency relationship of each application on other applications cannot be obtained in real time in an application deployment stage. In addition, in the system, each application has a method for describing its own dependency relationship, which is generally limited to static dependencies such as library files and the like, and there is no method for describing system services or other applications and the like on which the application depends.

In an embodiment of the described techniques, in a development stage of a current application, writing the dependency relationship of each application into the dependency description file carried by the current application, includes: adopting an Interface Definition Language (IDL), and quoting an interface definition file of an application on which the current application depends in an interface definition file of the current application; parsing the dependency relationship of the current application from the interface definition file of the current application by using an interface definition language parser; and generating the dependency description file based on the dependency relationship by using an interface definition language generator.

As is shown in FIG. 5, when any current application P uses an IDL to establish a connection with another application Q, it is only necessary to import and quote an interface definition file of the other application Q in an interface definition file of the current application P. An IDL parser may parse a dependency relationship of the current application P, and a generator generates a dependency description file of the current application P. The dependency description file comprises the dependency relationship of the current application P.

According to the technical solution of the above embodiments of the described techniques, a dependency relationship of each application is written into a dependency description file carried by a current application by using an interface definition language. The interface definition language is a computer language for describing a software component interface, and describes the interface in a way independent from a programming language, so that objects running on different platforms may communicate with each other. According to this solution, an interface is described in an interface definition language, for an application, only an interface definition file needs to be completed, then the interface definition file is parsed by a tool, specific codes are generated, a communication bridge between applications is realized, and an overall compatibility and a transportability are improved.

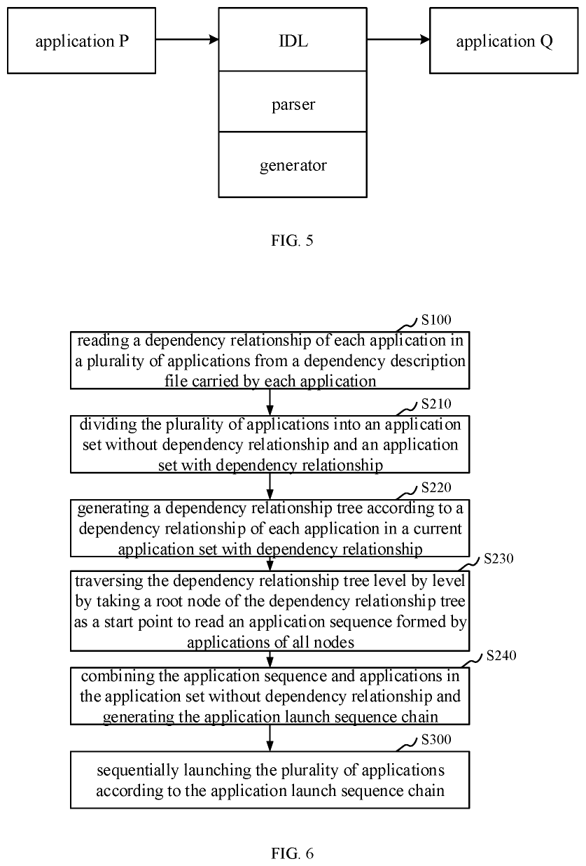

In one embodiment, as is shown in FIG. 6, the above described step S200 includes steps S210-S240:

step S210, dividing the plurality of applications into an application set without dependency relationship and an application set with dependency relationship.

In the described techniques, dependency relationships may be divided into active dependency relationships and passive dependency relationships. An application is considered to have an active dependency relationship when it depends on at least one other application; and an application is considered to have a passive dependency relationship when it is depended on by at least one other application. Based on this, when an application has an active dependency relationship and/or a passive dependency relationship, the application is called an application with dependency relationship; conversely, when an application has neither active nor passive dependency relationships, the application is referred to as an application without dependency relationship.

In this step, an application management module in a system may determine whether each application is an application with dependency relationship or an application without dependency relationship according to an information of a dependency relationship written in a dependency description file of each application, so that all applications with dependency relationship form an application set with dependency relationship, and all applications without dependency relationship form an application set without dependency relationship.

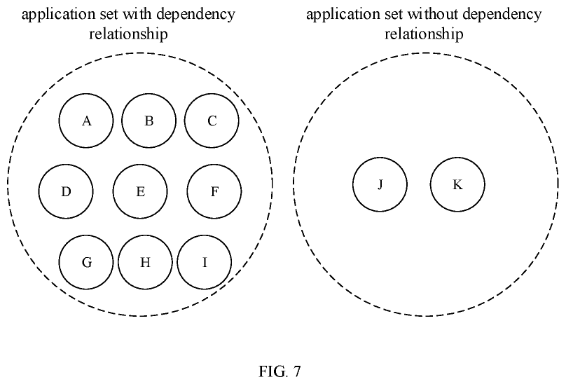

Illustratively, an application set with dependency relationship and an application set without dependency relationship shown in FIG. 7 may be determined according to the dependency relationship of applications A-K listed in the listing of FIG. 4.

Step S220, generating a dependency relationship tree according to a dependency relationship of each application in a current application set with dependency relationship.

The dependency relationship tree may have a typical tree structure, which may include a plurality of nodes distributed in a plurality of levels from top to bottom, wherein each node represents an application. Among the plurality of nodes, the topmost node is a root node, each node is connected with zero, one, or more child node(s) located at a next level (i.e., a plus one level) of a level of the node, and each node other than the root node is connected with one parent node located at a previous level (i.e., a minus one level) of the level of the node. Among them, a level closer to the top is referred to as a lower level, and a level closer to the bottom is referred to as a higher level.

In one embodiment, in a dependency relationship tree, for a node of each application, a node of an application on which a current application depends is located in a level lower than a location level of a node of the current application, and a node of an application depending on the current application is located in a level higher than the location level of the node of the current application. When a node of any one current application satisfies the above relationship, it may be referred to as that the node of the current application satisfies the dependency hierarchy relationship. In this way, a dependency priority relationship among applications may be well characterized by a hierarchical structure of a dependency relationship tree.

Given that a node of each application in a dependency relationship tree satisfies the above dependency hierarchy relationship, there may be many variations in a method of generating a dependency relationship tree, and a specific structure of a generated dependency relationship tree, for a same plurality of applications. In one embodiment of the described techniques, when a current application depends on one or more application(s), a node of the current application is connected as a child node of a highest level node in one or more node(s) corresponding to the one or more application(s) on which the current application depends, so that a dependency relationship tree embodies more dependency relationships between the applications, and an update of the dependency relationship tree in an application change operation to be described later is facilitated.

In one embodiment, the step S220 includes: determining a dependency relationship matrix table among applications in the current application set with dependency relationship according to the dependency relationship of each application in the current application set with dependency relationship; determining a dependency chain of the applications in the current application set with dependency relationship according to the dependency relationship matrix table; and determining the dependency relationship tree of the applications in the current application set with dependency relationship according to the dependency chain.

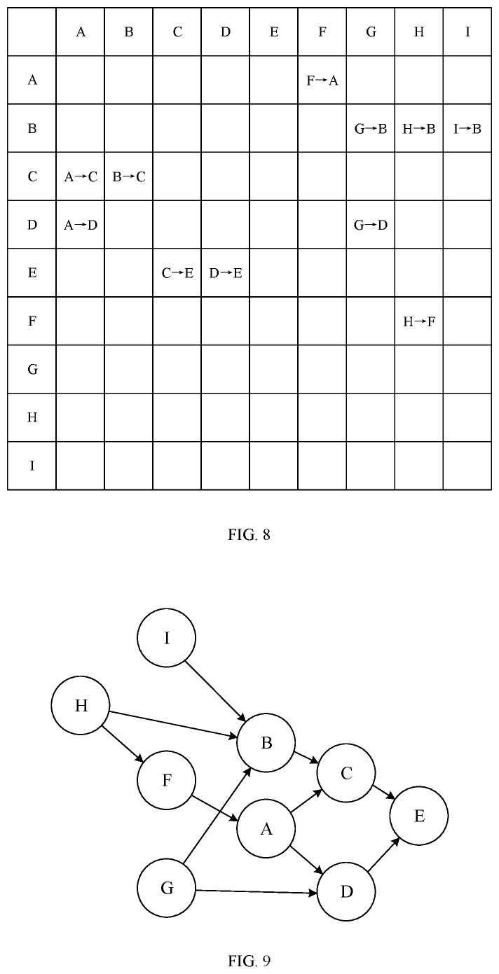

For example, for an application set with dependency relationship shown in FIG. 7, a corresponding dependency relationship matrix table, as is shown in FIG. 8, may be determined according to the dependency relationship of each application in the set. The dependency relationship matrix table is a two-dimensional matrix table, and indicates whether there is a dependency relationship between every two applications, and what the dependency relationship is if there is, for example, in row A of column C, there is a dependency relationship of an application A depending on an application C.

After determining the dependency relationship matrix table among all the applications in the application set with dependency relationship, a dependency relationship matrix table shown in FIG. 8 may be converted into a dependency chain as is shown in FIG. 9. The dependency chain shows a direct dependency relationship between two applications and also clearly shows direct or indirect dependency relationships among multiple applications. In this dependency chain, an arrow points from a current application to an application on which the current application depends.

In the above dependency chain, an arrow points to an application on which a current application depends, but at the time of launching, the application on which the current application depends needs to be launched first, so that it may be ensured that the current application may use the function of the application on which the current application depends when launching, so a launch sequence generally needs to be ordered from a tail to a head of a dependency chain. That is, one application may be determined as a root node from applications that depend on an application at a tail of a chain, and positions of nodes of other applications in a dependency relationship tree may be sequentially determined from the tail to the head.

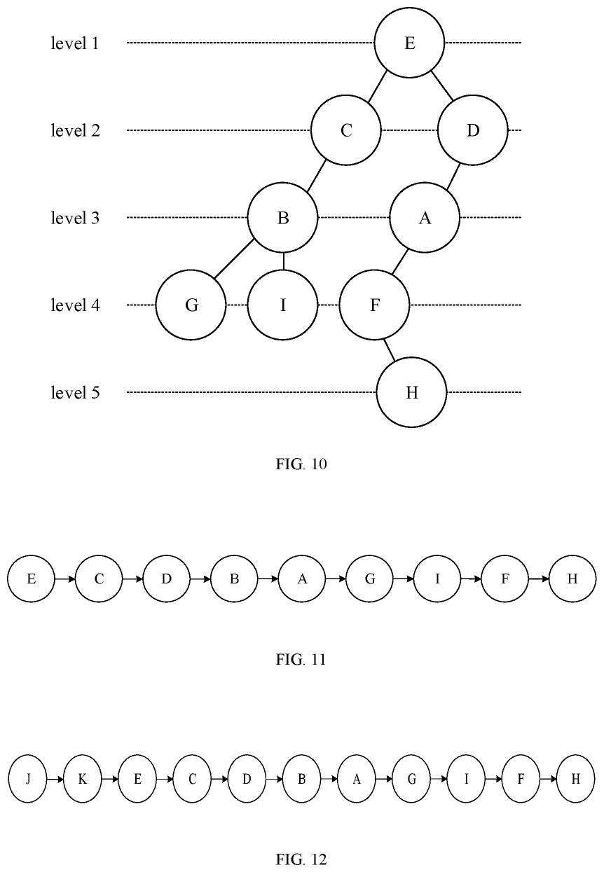

For example, according to a dependency chain as is shown in FIG. 9, a dependency relationship tree as is shown in FIG. 10 may be generated, in which an application E at a tail end of the dependency chain is taken as a root node, and when a current application depends on one or more application(s), a node of the current application is connected as a child node of a highest level node in the one or more node(s) corresponding to the one or more application(s) on which the current application depends.

Step S230, traversing the dependency relationship tree level by level by taking a root node of the dependency relationship tree as a starting point to read an application sequence formed by applications of all nodes.

Launch priorities of applications within each level in a dependency relationship tree are the same. Therefore, a sequence of applications in each level may be changed arbitrarily while keeping an arrangement order of applications among levels unchanged.

Illustratively, taking reading the applications in each level sequentially from left to right as an example, according to a height of a dependency relationship tree as is shown in FIG. 10, from a root node, using a hierarchical traversal algorithm, an application sequence as is shown in FIG. 11 may be obtained by traversing the dependency relationship tree level by level from the lowest level to the highest level.

Step S240, combining the application sequence and applications in the application set without dependency relationship and generating the application launch sequence chain.

In one embodiment, the step S240 includes: under a condition of keeping an application arrangement sequence in the application sequence unchanged, connecting head to tail the application sequence and various applications in the application set without dependency relationship to generate the application launch sequence chain.

A launch priority of each application in the application set without dependency relationship is the same as a launch priority of the application sequence determined in the previous step. Therefore, under the condition of keeping the application arrangement sequence in the application sequence unchanged, a sequence between each application in the application set without dependency relationship and the application sequence may be changed at will.

Illustratively, taking arranging applications in an application set without dependency relationship before an application sequence as an example, applications I and J in an application set without dependency relationship may be accessed at a head end of an application sequence as is shown in FIG. 11 to generate an application launch sequence chain as is shown in FIG. 12.

According to the technical solutions of embodiments of the described techniques, a dependency priority among applications having dependency relationships is combed by utilizing a hierarchical structure of a dependency relationship tree, to generate an application sequence arranged according to a launch priority, and combine the application sequence with an application set without dependency relationship to generate an application launch sequence chain. The application launch sequence chain is able to be generated efficiently and correctly.

Applications in a system are not invariable, after an initial deployment of applications in an electronic device 102 in an application deployment stage, a new application may be installed or an existing application may be updated in a subsequent running process of the electronic device 102, and a change of an application may cause a change of dependency relationship of applications, so that an application launch sequence chain also needs to be updated each time an application is changed.

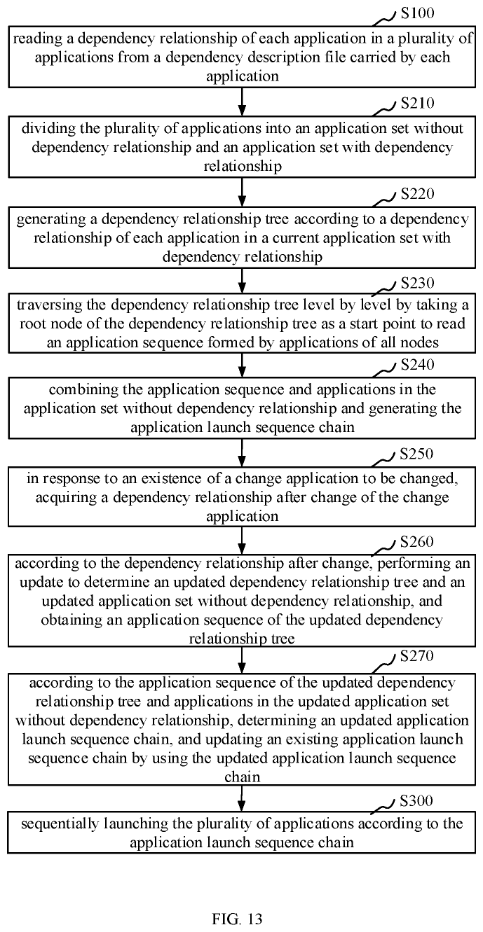

In one embodiment, as is shown in FIG. 13, the method for application launch may further include following steps S250-S270:

step S250, in response to an existence of a change application to be changed, acquiring a dependency relationship after change of the change application;

wherein the change application to be changed may include a new application to be installed or an existing application to be updated. For a new application to be installed, the dependency relationship after change is a dependency relationship it has, and for an existing application to be updated, the dependency relationship after change is a dependency relationship it has in an updated version.

Step S260, according to the dependency relationship after change, performing an update to determine an updated dependency relationship tree and an updated application set without dependency relationship, and obtaining an application sequence of the updated dependency relationship tree;
in one embodiment, in response to the change application to be changed being a new application to be installed, according to the dependency relationship after change, performing the update to determine the updated dependency relationship tree and the updated application set without dependency relationship, includes:
in response to the new application not depending on any application, adding the new application into an existing application set without dependency relationship to obtain the updated application set without dependency relationship, and taking an existing dependency relationship tree as the updated dependency relationship tree;
in response to the new application depending on one or more application(s), accessing a node of the new application as a child node of a node of a most posterior application in an existing application launch sequence chain in the one or more application(s) on which the new application depends, to determine the updated application set without dependency relationship and the updated dependency relationship tree.

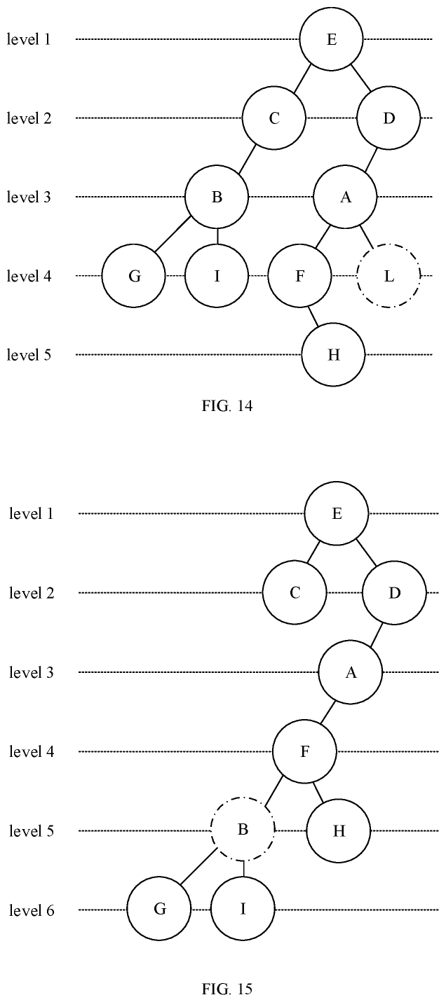

Illustratively, based on a dependency relationship tree shown in FIG. 10, in response to an existence of a new application L to be installed, in response to the new application L depending on an application C and an application A, a node of the new application L may be accessed as a child node of a node of the application A, to determine an updated dependency relationship tree, as is shown in FIG. 14.

In one embodiment, in response to the change application to be changed being an existing application to be updated, performing the update to determine the updated dependency relationship tree and the updated application set without dependency relationship, includes:
in response to the existing application after update not depending on any application, taking an existing application set without dependency relationship as the updated application set without dependency relationship, and taking an existing dependency relationship tree as the updated dependency relationship tree;
in response to the existing application after update depending on one or more application(s) and there being no application depending on the existing application, accessing a node of the existing application as a child node of a node of a most posterior application in an existing application launch sequence chain in the one or more application(s) on which the existing application depends, to determine the updated application set without dependency relationship and the updated dependency relationship tree; and
in response to the existing application after update depending on one or more application(s) and there being one or more application(s) depending on the existing application, for the existing application and each of the application(s) depending on the existing application directly or indirectly, updating a node position of a current application, so that a node of an application on which the current application depends after update is located in a level lower than a location level of a node of the current application, and a node of an application depending on the current application is located in a level higher than the location level of the node of the current application, to determine the updated application set without dependency relationship and the updated dependency relationship tree.

In the described techniques, when one application a depends on another application b, that is, when the application b is recorded in a dependency description file of the application a, it may be referred to that the application a depends on or directly depends on the application b, and when one application a depends on another application b and the application b depends on an application c, it may be referred to that the application a indirectly depends on the application c.

In one embodiment, in response to the existing application after update depending on one or more application(s) and there being one or more application(s) depending on the existing application, for the existing application and each of the application(s) depending on the existing application directly or indirectly, updating the node position of the current application, so that the node(s) of the application(s) on which the current application depends after update is located in a level lower than the location level of the node of the current application, and the node(s) of the application(s) depending on the current application is located in the level higher than the location level of the node of the current application, to determine the updated application set without dependency relationship and the updated dependency relationship tree, comprises:
taking an existing application set without dependency relationship as the updated application set without dependency relationship;
determining a node of a most posterior application in an existing application launch sequence chain among the one or more application(s) on which the existing application depends after update;
in response to a level of the node of the most posterior application being lower than or equal to a level of a parent node connected with the node of the existing application before update, taking an existing dependency relationship tree as the updated dependency relationship tree; and
in response to the level of the node of the most posterior application being higher than the level of the parent node connected with the node of the existing application before update, disconnecting the node of the current application together with each child node directly or indirectly connected with the node of the current application from the parent node connected with the node of the current application, and connecting the node of the current application together with each child node directly or indirectly connected with the node of the current application with the node of the most posterior application as a child node; and then checking, except each child node directly or indirectly connected with the node of the current application, whether there is any node not satisfying a dependency hierarchy relationship in nodes of applications directly or indirectly depending on the current application, in response to no, taking a current dependency relationship tree as the updated dependency relationship tree, and in response to yes, changing a position of a node not satisfying the dependency hierarchy relationship until all nodes satisfy the dependency hierarchy relationship, and taking a dependency relationship tree at this time as the updated dependency relationship tree.

For example, on the basis of a dependency relationship tree shown in FIG. 10, in response to there being an existing application F to be updated, in response to after update the existing application F depending on an application C and an application D, it may be determined that a most posterior application in an existing application launch sequence chain shown in FIG. 12 of the application C and the application D, on which the application F depends after update, is the application D, and a level 2 where a node of the application D is located is lower than a level 3 where a parent node, i.e., a node of the application A, connected with the existing application F before update is located. In this case, an application dependency requirement may also be satisfied without a need to adjust a node position of the existing application F, and an existing dependency relationship tree shown in FIG. 10 is used as the updated dependency relationship tree, thereby greatly saving computational resources and improving computational efficiencies.

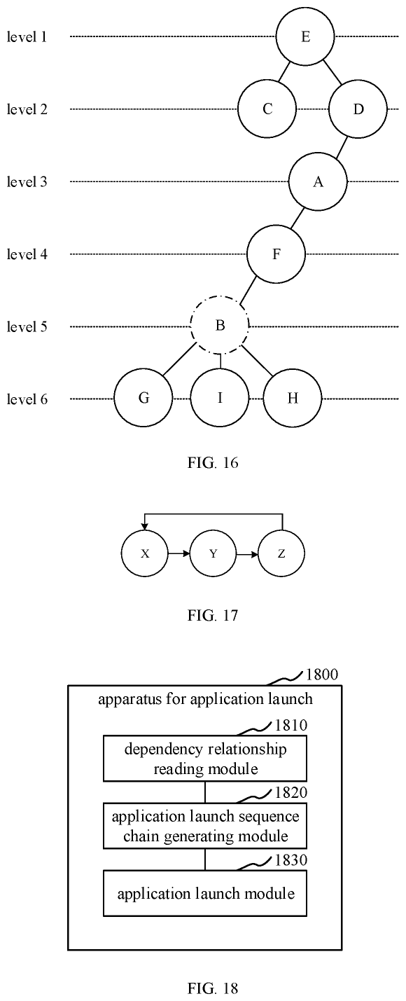

For example, on the basis of a dependency relationship tree shown in FIG. 10, in response to there being an existing application B to be updated, in response to the existing application B after update depending on an application F and an application C, it may be determined that a most posterior application in an existing application launch sequence chain shown in FIG. 12 of the application F and the application C, on which the application B depends after update, is the application F, and a level 4 where a node of the application F is located is higher than a level 2 where a parent node, i.e., a node of the application C, connected with the existing application B before update is located. In this case, firstly a node of the existing application B together with each child node (including nodes of applications G, I) directly or indirectly connected with the node of the existing application B may be disconnected from the parent node (i.e., the node of the application C) connected with the node of the existing application B, and the node of the existing application B together with each child node (including the nodes of the applications G, I) directly or indirectly connected with the node of the existing application B is connected with the node of the most posterior application F as a child node, as is shown in FIG. 15. Next, except the nodes of the applications G, I, whether each application in applications (including an application H) directly or indirectly depending on the application B satisfies a dependency hierarchy relationship is checked one by one, a level 5 where the application H is located is found to be equal to a level of the application B on which the application H depends and does not satisfy the dependency hierarchy relationship, a position of a node of the application H is adjusted to be a child node of the node of the application B, as is shown in FIG. 16, and an existing dependency relationship tree shown in FIG. 16 is taken as the updated dependency relationship tree.

Step S270, according to the application sequence of the updated dependency relationship tree and applications in the updated application set without dependency relationship, determining an updated application launch sequence chain, and updating an existing application launch sequence chain by using the updated application launch sequence chain.

It may be appreciated that after the application launch sequence chain is updated, the applications are launched sequentially during an application launch stage in accordance with the updated application launch sequence chain.

According to technical solutions of above embodiments of the described techniques, in response to an existence of a change application to be changed, according to different dependency relationship situations, a dependency relationship tree and an application set without dependency relationship are locally updated in a small range to update an application launch sequence chain, and there is no need to restart to generate the updated application launch sequence chain, so that computational resources are saved, and computational efficiencies are improved.

In one embodiment, the above method for application launch further includes:
in response to an existence of a change application to be changed, acquiring a dependency relationship after change of the change application;
according to the dependency relationship after change, checking whether a cyclic dependency chain exists; and
in response to the cyclic dependency chain existing, stopping updating the change application into an existing application launch sequence chain, and sending an alarm information to an application developer terminal associated with the change application.

New applications are continuously installed or updated in a system, and a dependency relationship tree in the system needs to be updated every time an application is installed or updated, so that a problem of cyclic dependency may occur. A cyclic dependency refers to a situation where a certain application directly or indirectly depends on another application, which in turn directly or indirectly depends on the certain application. For example, for applications X, Y, Z, if the X application depends on the Y application, the Y application depends on the Z application, and the Z application depends on the X application, a circular dependency chain, i.e., a cyclic dependency chain, of X→Y→Z→X as is shown in FIG. 17 would result, in which case a reasonable launch sequence of the applications X, Y, Z could not be determined.

When a launch sequence is generated, if a cyclic dependency phenomenon occurs, a normal operation cannot be ensured for each application. A root cause of the cyclic dependency is that there are problems with applications in design. In the above embodiments of the described techniques, in response to an existence of a change application to be changed, a dependency chain may be updated, and an updated dependency chain is checked on whether there is a cyclic dependency chain situation. In response to an encounter of a cyclic dependency, the current change application is stopped from being updated into an existing application launch sequence chain, and an alarm information is sent to an application developer terminal associated with the change application, so as to feed back the cyclic dependency information of the application to the application developer, thereby helping the application developer modify the dependency relationship of the application.

It should be understood that, although steps in flowcharts of FIGS. 3, 6, and 13 are shown in order as indicated by arrows, the steps are not necessarily performed in order as indicated by the arrows. The steps are not performed in the exact order shown and described, and may be performed in other orders, unless explicitly stated otherwise in this disclosure. Moreover, at least some of the steps in FIGS. 3, 6, and 13 may include multiple sub-steps or multiple stages, which are not necessarily performed at the same time, but may be performed at different times, and the order of performing the sub-steps or stages is not necessarily sequential, but may be performed in turn or alternately with other steps or at least some of the sub-steps or stages of other steps.

In one embodiment, as is shown in FIG. 18, there is provided an apparatus 1800 for application launch, comprising: a dependency relationship reading module 1810, an application launch sequence chain generating module 1820, and an application launch module 1830, wherein:
the dependency relationship reading module 1810 is configured for reading a dependency relationship of each application in a plurality of applications from a dependency description file carried by each application;
the application launch sequence chain generating module 1820 is configured for generating an application launch sequence chain according to the dependency relationship; and
the application launch module 1830 is configured for sequentially launching the plurality of applications according to the application launch sequence chain.

In one embodiment, the apparatus 1800 for application launch further comprises an application launch sequence chain updating module configured for:
in response to an existence of a change application to be changed, acquiring a dependency relationship after change of the change application;
according to the dependency relationship after change, performing an update to determine an updated dependency relationship tree and an updated application set without dependency relationship, and obtaining an application sequence of the updated dependency relationship tree; and
according to the application sequence of the updated dependency relationship tree and applications in the updated application set without dependency relationship, determining an updated application launch sequence chain, and updating an existing application launch sequence chain by using the updated application launch sequence chain.

For specific definitions of the apparatus 1800 for application launch, reference may be made to the above definitions of the method for application launch, and they are not described herein again. Various modules in the above apparatus 1800 for application launch may be implemented in whole or in part by software, hardware, and combination(s) thereof. The above modules may be embedded in a hardware form in or independent of a processor in an electronic device, or may be stored in a memory in an electronic device in a software form, so that the processor may call and execute operations corresponding to the above modules.

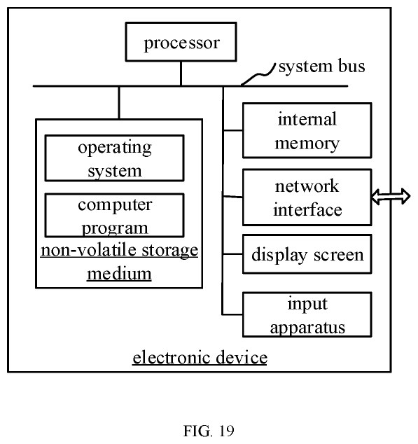

In one embodiment, an electronic device is provided. The electronic device may be a terminal, an internal structure diagram of which may be as is shown in FIG. 19. The electronic device comprises a processor, a memory, a network interface, a display screen and an input apparatus which are connected through a system bus. The processor of the electronic device is configured to provide computing and control capabilities. The memory of the electronic device comprises a non-volatile storage medium and an internal memory. The non-volatile storage medium stores an operating system and a computer program. The internal memory provides an environment for an operation of the operating system and the computer program in the non-volatile storage medium. The network interface of the electronic device is used for connecting and communicating with an external terminal through a network. The computer program is executed by a processor to implement a method for application launch. The display screen of the electronic device may be a liquid crystal display screen or an electronic ink display screen, and the input apparatus of the electronic device may be a touch layer covered on the display screen, a key, a track ball or a touch pad arranged on a shell of the electronic device, or an external keyboard, touch pad or mouse, and the like.

Those skilled in the art may appreciate that the configuration shown in FIG. 19 is a block diagram of only a portion of the configuration relevant to the described techniques, and does not constitute a limitation on an electronic device to which the described techniques are applied, and a particular electronic device may include components more or less than those shown in the drawings, or combine certain components, or have a different arrangement of components.

In one embodiment, an electronic device is provided, and comprises a memory and a processor, the memory has a computer program stored therein, and when executing the computer program, the processor implements following steps:
reading a dependency relationship of each application in a plurality of applications from a dependency description file carried by each application;
generating an application launch sequence chain according to the dependency relationship; and
sequentially launching the plurality of applications according to the application launch sequence chain.

In other embodiments, the processor, when executing the computer program, further performs steps of the method for application launch of any of the above embodiments.

In one embodiment, a computer-readable storage medium is provided, and stores thereon a computer program, which, when executed by a processor, performs steps of:
reading a dependency relationship of each application in a plurality of applications from a dependency description file carried by each application;
generating an application launch sequence chain according to the dependency relationship; and
sequentially launching the plurality of applications according to the application launch sequence chain.

In other embodiments, the computer program, when executed by the processor, further performs steps of the method for application launch of any of the above-described embodiments.

It may be understood by those skilled in the art that all or part of processes of the methods of the embodiments described above may be implemented by hardware relevant to instructions of a computer program, which may be stored in a non-volatile computer-readable storage medium, and when executed, may include processes of the embodiments of the methods described above. Any reference to a memory, a storage, a database, or other medium used in embodiments provided in this application may include a non-volatile and/or volatile memory, among others. A non-volatile memory may include a read-only memory (ROM), a programmable ROM (PROM), an electrically programmable ROM (EPROM), an electrically erasable programmable ROM (EEPROM), or a flash memory. A volatile memory may include a random access memory (RAM) or an external cache memory. By way of illustration and not limitation, an RAM is available in a variety of forms such as a static RAM (SRAM), a dynamic RAM (DRAM), a synchronous DRAM (SDRAM), a double data rate SDRAM (DDRSDRAM), an enhanced SDRAM (ESDRAM), a synchronous link (Synchlink) DRAM (SLDRAM), a rambus (Rambus) direct RAM (RDRAM), a direct rambus dynamic RAM (DRDRAM), and a rambus dynamic RAM (RDRAM), among others.

Various technical features of the above embodiments may be arbitrarily combined, and for the sake of brevity, not all possible combinations of the technical features in the above embodiments are described. However, as long as there is no contradiction in the combinations of these technical features, they should be considered as the scope of the present specification.

The above-mentioned embodiments only express several embodiments of the described techniques, and the description thereof is relatively specific and detailed, but should not be construed to limit the scope of the invention. It should be noted that, for a person skilled in the art, without departing from the concept of the described techniques, several variations and modifications may also be made, and fall within the scope of protection of the described techniques. Therefore, the protection scope of the described techniques shall be subject to the appended claims.

What is claimed is:

1. A method for application launch, the method comprising:
reading a dependency relationship of each application in a plurality of applications from a dependency description file carried by each application;
generating an application launch sequence chain according to the dependency relationship; and
sequentially launching the plurality of applications according to the application launch sequence chain.

2. The method according to claim 1, wherein the dependency relationship of each application is written into a dependency description file carried by a current application in a development stage of the current application.

3. The method according to claim 2, wherein writing the dependency relationship of each application into the dependency description file carried by the current application, comprises:
by adopting an interface definition language, quoting an interface definition file of an application on which the current application depends in an interface definition file of the current application;
parsing the dependency relationship of the current application from the interface definition file of the current application by using an interface definition language parser; and
generating the dependency description file based on the dependency relationship by using an interface definition language generator.

4. The method according to claim 1, wherein generating the application launch sequence chain according to the dependency relationship, comprises:
dividing the plurality of applications into an application set without dependency relationships and an application set with dependency relationships;
generating a dependency relationship tree according to a dependency relationship of each application in a current application set with dependency relationship;
traversing the dependency relationship tree level by level by taking a root node of the dependency relationship tree as a starting point to read an application sequence formed by applications of all nodes; and
combining the application sequence and applications in the application set without dependency relationship and generating the application launch sequence chain.

5. The method according to claim 4, wherein generating the dependency relationship tree according to the dependency relationship of each application in the current application set with dependency relationship, comprises:
determining a dependency relationship matrix table among applications in the current application set with dependency relationships according to the dependency relationship of each application in the current application set with dependency relationships;
determining a dependency chain of the applications in the current application set with dependency relationships according to the dependency relationship matrix table; and
determining the dependency relationship tree of the applications in the current application set with dependency relationships according to the dependency chain.

6. The method according to claim 4, wherein in the dependency relationship tree, for a node of each application, a node of an application on which a current application depends is located a level lower than a location level of a node of the current application, and a node of an application depending on the current application is located at a level higher than the location level of the node of the current application.

7. The method according to claim 4, further comprising:
in response to determining that a change application is to be changed, acquiring a dependency relationship after the change of the change application;
according to the dependency relationship after the change, performing an update to determine an updated dependency relationship tree and an updated application set without dependency relationship, and obtaining an application sequence of the updated dependency relationship tree; and
according to the application sequence of the updated dependency relationship tree and applications in the updated application set without dependency relationships, determining an updated application launch sequence chain, and updating an existing application launch sequence chain by using the updated application launch sequence chain.

8. The method according to claim 7, wherein the change of the change application is to install a new application, wherein in response to determining that the change application is to be changed, according to the dependency relationship after the change, performing the update to determine the updated dependency relationship tree and the updated application set without dependency relationships, wherein performing the update comprises:
in response to determining the new application not depending on any application, adding the new application into an existing application set without dependency relationships to obtain the updated application set without dependency relationships, and taking an existing dependency relationship tree as the updated dependency relationship tree; and
in response to determining the new application depending on one or more application(s), accessing a node of the new application as a child node of a node of a most posterior application in an existing application launch sequence chain in the one or more applications(s) on which the new application depends, to determine the updated application set without dependency relationships and the updated dependency relationship tree.

9. The method according to claim 7, wherein the change of the change application is to update an existing application, wherein in response to determining that the change application is to be changed, according to the dependency relationship after the change, performing the update to determine the updated dependency relationship tree and the updated application set without dependency relationships, wherein performing the update comprises:
in response to determining that the existing application after the update does not depend on any application, taking an existing application set without dependency relationships as the updated application set without dependency relationships, and taking an existing dependency relationship tree as the updated dependency relationship tree;
in response to determining that the existing application after the update depends on one or more applications and there is no application depending on the existing application, accessing a node of the existing application as a child node of a node of a most posterior application in an existing application launch sequence chain in the one or more applications on which the existing application depends, to determine the updated application set without dependency relationships and the updated dependency relationship tree; and
in response to determining that the existing application after update depends on one or more applications and there are one or more applications depending on the existing application, for the existing application and each of the applications depending on the existing application directly or indirectly, updating a node position of a current application, so that a node of an application on which the current application depends after the update is located at a level lower than a location level of a node of the current application, and a node of an application depending on the current application is located at a level higher than the location level of the node of the current application, to determine the updated application set without dependency relationships and the updated dependency relationship tree.

10. The method according to claim 4, further comprising:
in response to determining that a change application is to be changed, acquiring a dependency relationship after the change of the change application;
according to the dependency relationship after the change, checking that a cyclic dependency chain exists; and
in response to determining that the cyclic dependency chain exist, stopping updating the change application into an existing application launch sequence chain, and sending alarm information to an application developer terminal associated with the change application.

11. The method according to claim 4, wherein combining the application sequence and the applications in the application set without dependency relationships and generating the application launch sequence chain, comprises:
under a condition of keeping an application arrangement sequence in the application sequence unchanged, connecting head to tail the application sequence and various applications in the application set without dependency relationships to generate the application launch sequence chain.

12. (canceled)

13. An electronic device comprising a memory and a processor, the memory storing a one or more instructions that, once executed by the processor, cause the processor to perform operations, the operations comprising:
reading a dependency relationship of each application in a plurality of applications from a dependency description file carried by each application;
generating an application launch sequence chain according to the dependency relationship; and
sequentially launching the plurality of applications according to the application launch sequence chain.

14. One or more computer-readable storage media, storing thereon one or more instructions that, once executed by one or more processors, cause the one or more processors to perform operations, the operations comprising:
reading a dependency relationship of each application in a plurality of applications from a dependency description file carried by each application;
generating an application launch sequence chain according to the dependency relationship; and
sequentially launching the plurality of applications according to the application launch sequence chain.

15. The electronic device according to claim 13, wherein the dependency relationship of each application is written into a dependency description file carried by a current application in a development stage of the current application.

16. The electronic device according to claim 15, wherein writing the dependency relationship of each application into the dependency description file carried by the current application, comprises:
by adopting an interface definition language, quoting an interface definition file of an application on which the current application depends in an interface definition file of the current application;
parsing the dependency relationship of the current application from the interface definition file of the current application by using an interface definition language parser; and
generating the dependency description file based on the dependency relationship by using an interface definition language generator.

17. The electronic device according to claim 13, wherein generating the application launch sequence chain according to the dependency relationship, comprises:
dividing the plurality of applications into an application set without dependency relationships and an application set with dependency relationships;
generating a dependency relationship tree according to a dependency relationship of each application in a current application set with dependency relationships;
traversing the dependency relationship tree level by level by taking a root node of the dependency relationship tree as a starting point to read an application sequence formed by applications of all nodes; and
combining the application sequence and applications in the application set without dependency relationships and generating the application launch sequence chain.

18. The electronic device according to claim 17, wherein generating the dependency relationship tree according to the dependency relationship of each application in the current application set with dependency relationships, comprises:
determining a dependency relationship matrix table among applications in the current application set with dependency relationships according to the dependency relationship of each application in the current application set with dependency relationships p;
determining a dependency chain of the applications in the current application set with dependency relationships according to the dependency relationship matrix table; and
determining the dependency relationship tree of the applications in the current application set with dependency relationships according to the dependency chain.

19. The one or more computer-readable storage media according to claim 14, wherein the dependency relationship of each application is written into a dependency description file carried by a current application in a development stage of the current application.

20. The one or more computer-readable storage media according to claim 19, wherein writing the dependency relationship of each application into the dependency description file carried by the current application, comprises:
by adopting an interface definition language, quoting an interface definition file of an application on which the current application depends in an interface definition file of the current application;
parsing the dependency relationship of the current application from the interface definition file of the current application by using an interface definition language parser; and
generating the dependency description file based on the dependency relationship by using an interface definition language generator.

21. The one or more computer-readable storage media according to claim 14, wherein generating the application launch sequence chain according to the dependency relationship, comprises:
dividing the plurality of applications into an application set without dependency relationships and an application set with dependency relationships;
generating a dependency relationship tree according to a dependency relationship of each application in a current application set with dependency relationships;
traversing the dependency relationship tree level by level by taking a root node of the dependency relationship tree as a starting point to read an application sequence formed by applications of all nodes; and
combining the application sequence and applications in the application set without dependency relationships and generating the application launch sequence chain.
